(19) United States
(12) Patent Application Publication
(10) Pub. No.: US 2004/0055867 A1
(43) Pub. Date: Mar. 25, 2004

(54) Method for separating at least one reactive component from a mixtures of liquid materials and device for carrying out said method

(76) Inventors: Erik Stein, Schifferstadt (DE); Kai Sundmacher, Helmstedt (DE); Achim Kienle, Magdeburg (DE)

Correspondence Address: IP DEPARTMENT OF PIPER RUDNICK LLP, 3400 TWO LOGAN SQUARE, 18TH AND ARCH STREETS, PHILADELPHIA, PA, 19103, US

(21) Appl. No.: 10/416,904

(22) PCT Filed: Nov. 15, 2001
(86) PCT No.: PCT/EP01/13243

(30) Foreign Application Priority Data
Nov. 15, 2000 (DE) 100 56 685.5

(51) Int. Cl. B01D 3/34

(52) U.S. Cl. 203/38

(57) ABSTRACT

The invention pertains to a process for separating at least one reactive component from a liquid mixture of substances with at least two coupled reactive distillation columns in which at least one secondary product is removed from the system. The invention also describes devices for implementing this process.

The present invention pertains to a process for separating at least one reactive component from mixtures of substances in liquid form in a system of at least two coupled reactive distillation columns. The invention also pertains to a device for the implementation of the process.

In chemical process engineering usually mixtures of substances are present which for further processing or directly as the product must be broken down into the individual components with a specified purity. The standard process for separation of substances is distillation or rectification. In this process liquid and vapor flow in countercurrent in a column, as a result of which the components with a low boiling point become concentrated at the head of the column and components with a higher boiling point remain at the bottom of the column. The separation of close-boiling mixtures with similar boiling points involves high equipment and energy costs. Therefore possibilities of saving on investment or energy costs are of great economic importance.

If substances which cannot be separated by distillation differ strongly in chemical properties it is possible to separate one or several components reactively. In this case said components react with a suitable reaction partner to form new substances which now because of their material properties (e.g., boiling point) can easily be separated from the remaining mixture. This reaction must be reversible in order for them to be split back into the initial components again after removal of the reaction products. The reaction partners are returned to the first stage of the process, while the desired components are separated in the required purity. The reaction conditions for the forward and backward reaction may clearly differ in this case, e.g., in the pressure and temperature range or in the nature and quantity of the catalyst used.

Such reactive separations are performed by reactive distillation (RD). The term reactive distillation (RD) refers to simultaneous processes of reaction and separation in one device, ordinarily a reactive distillation column (RDC). Typical examples are esterifications, e.g., the synthesis of methyl acetate, or etherifications, e.g., the synthesis of methyl tert-butyl ether (MTBE). In both examples RDCs are used on a large industrial scale.

Reactive separations using RDCs are already known for various material systems. Thus in “Ind. Eng. Chem. Process. Des. Dev.” 1985, volume 24, pp. 1062 ff. the separation of m-xylene and p-xylene is described where sodium p-xylene is used as the entraining agent. In this reactive distillation an inlet is provided for the xylenes while the two components p-xylene and m-xylene exit through two outlets.

The reactive separation of a mixture of 3-picoline and 4-picoline is known from “Comput. Chem. Engng.”, 1988, volume 12, pp. 1141 ff. In this reactive distillation process trifluoroacetic acid, chloropyridine and nitromethane are used as the solvents. The installation shown consists of two reactive distillation columns and four nonreactive columns.

The article in “Chemical Technology (RSA)”, March/April 1999, pp. 1 ff. reports quite generally on coupled reactive distillation columns. On the flow chart shown there a mixture of components A and B is separated through a nonreactive column (A) and a reactive regeneration column (B). Other components appearing in the flow chart remain in the system and are not led to the outside,

The main problem in reactive separations is the fact that as a rule undesired secondary reactions occur. In this case part of the initial substances to be separated is transformed into secondary products with the result that the product yield of the individual components is substantially reduced, and secondary products may accumulate due to the recycling of the above-mentioned reaction partner.

It is therefore the objective of the present invention to devise a process for reactive distillation as well as a device with which the secondary products appearing upon the separation of the components of a mixture of substances can be controlled in order to obtain the components in pure form and in high yields and to avoid the abovementioned accumulation effects.

This problem is solved by the process according to claim 1. The subsequent claims pertain to preferred variants of the process of the invention.

The problem of the invention is also solved by a device as defined in claim 22. The subsequent claims describe preferred variants of the device according to the invention.

The present invention therefore pertains to a process for separating at least one reactive component from a liquid mixture of substances in a system of at least two coupled reactive distillation columns with a forming column and a splitting column in which at least one secondary product is removed from the system.

The present invention is explained in more detail with reference to the figures which show:

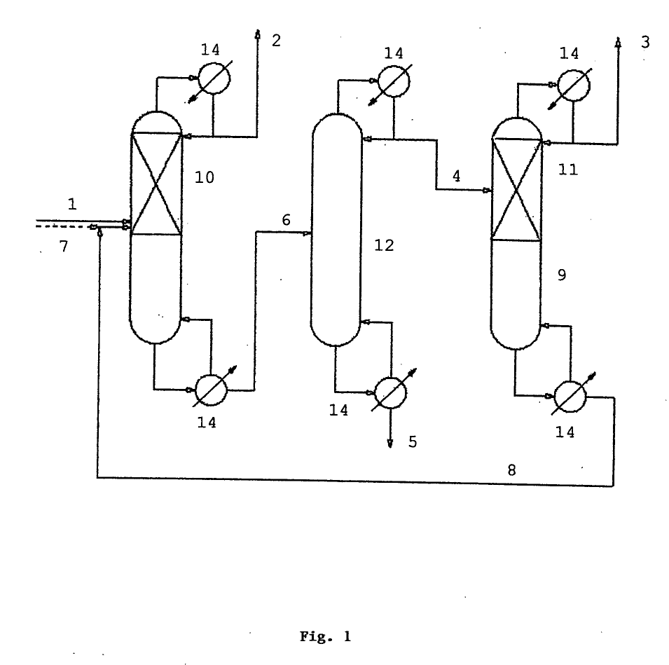

FIG. 1: a device with a column system for implementing one variant of the process of the invention in which a nonreactive distillation column is interposed;

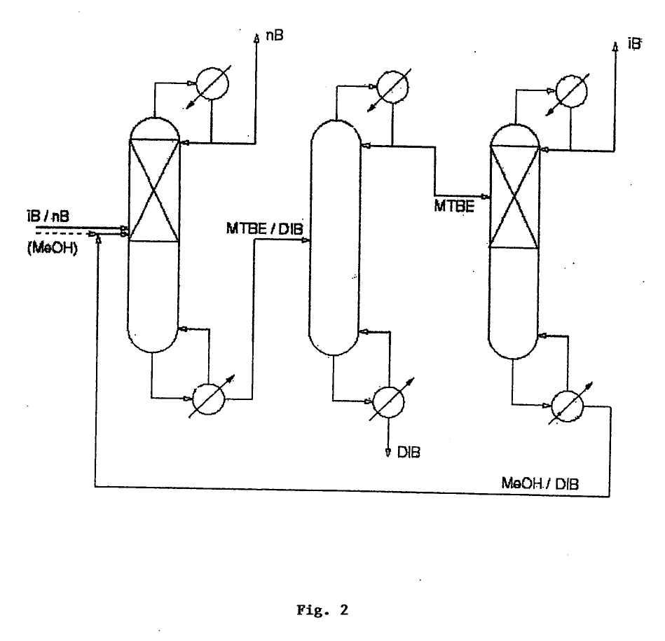

FIG. 2: an example of the variant shown in FIG. 1 for separation of the mixture isobutene/n-butene;

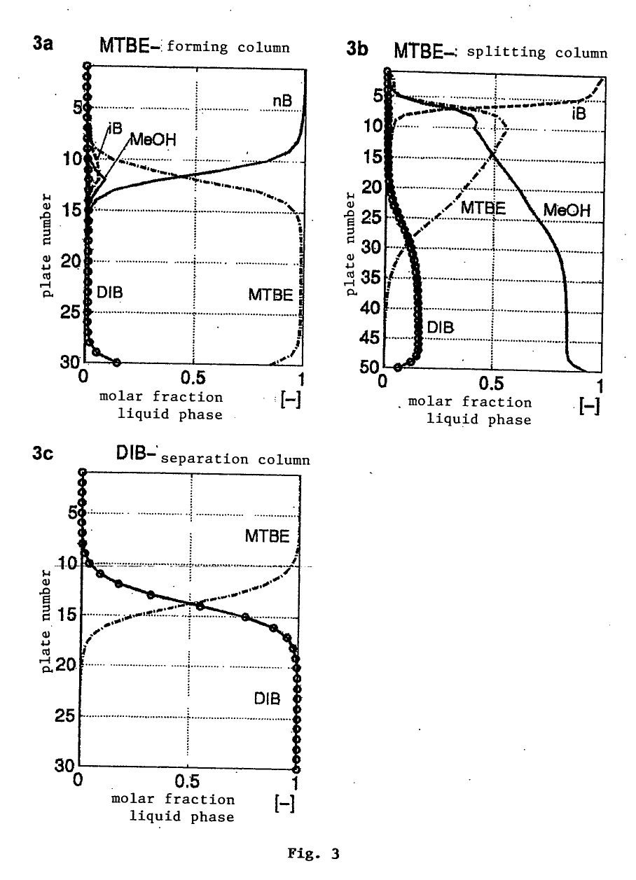

FIGS. 3a to 3c: concentration profiles of the individual components in the three columns shown in FIG. 2;

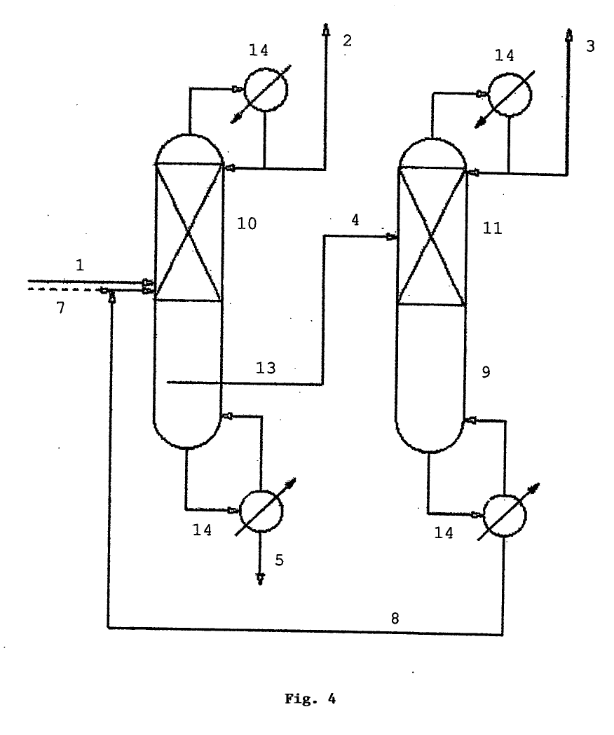

FIG. 4: a device with a column system for implementing another variant of the process of the invention in which a vapor side outlet is provided on the forming column;

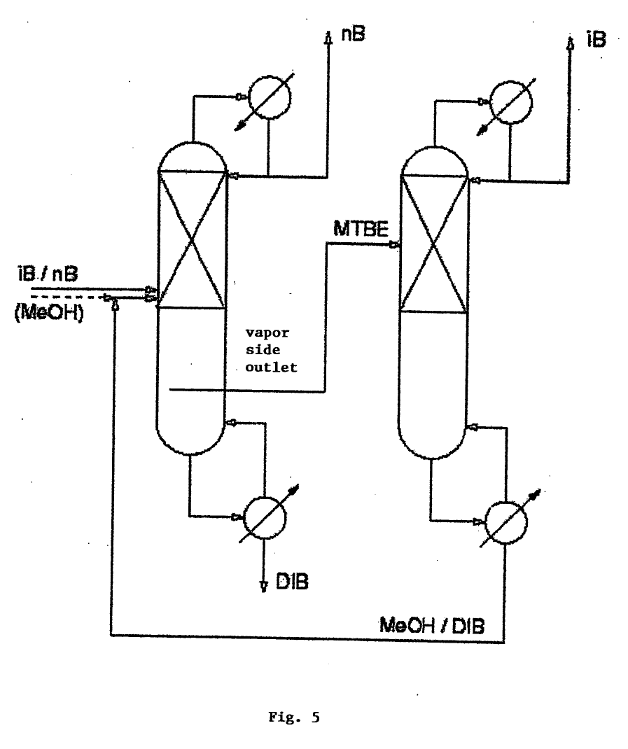

FIG. 5: an example of the variant shown in FIG. 4 for separation of the mixture isobutene/n-butene; and

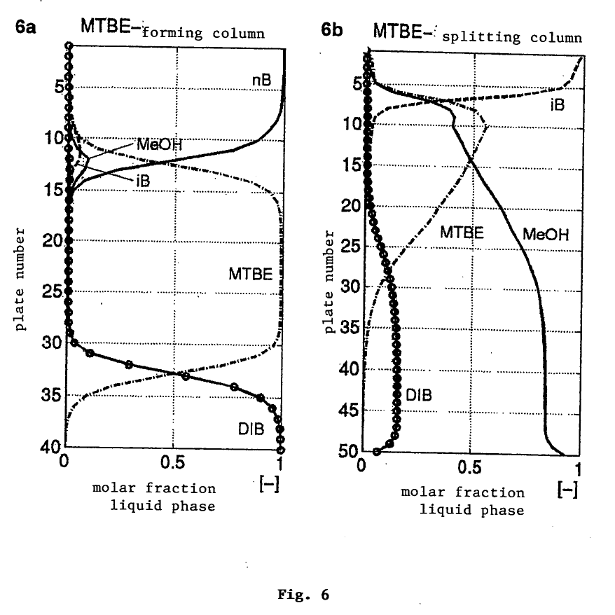

FIGS. 6a, 6b: concentration profiles of the individual components in the two columns in FIG. 5.

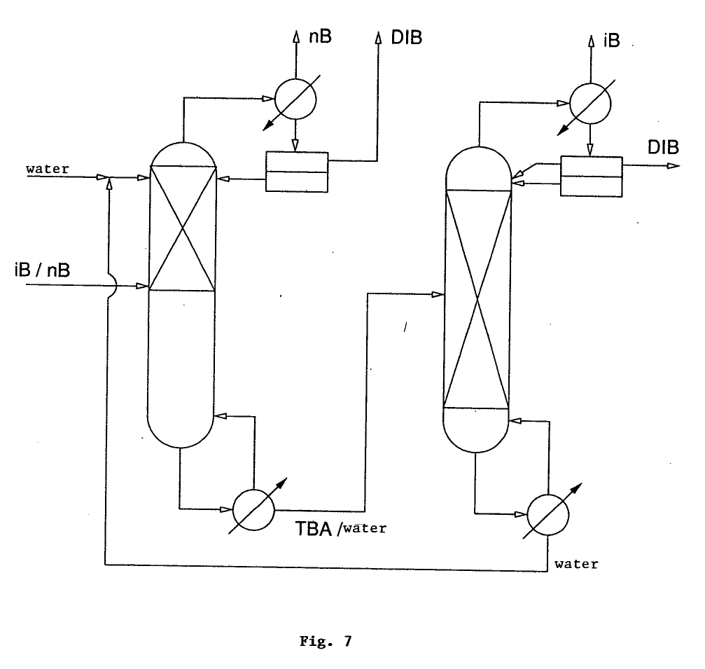

FIG. 7: another variant of the process according to the invention for separation of the mixture isobutene/n-butene,

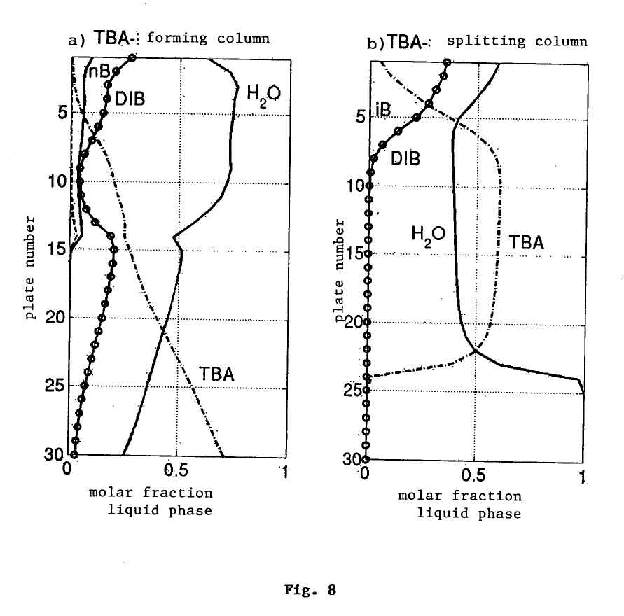

FIGS. 8a, 8b: concentration profiles of the individual components in the columns in FIG. 7, and

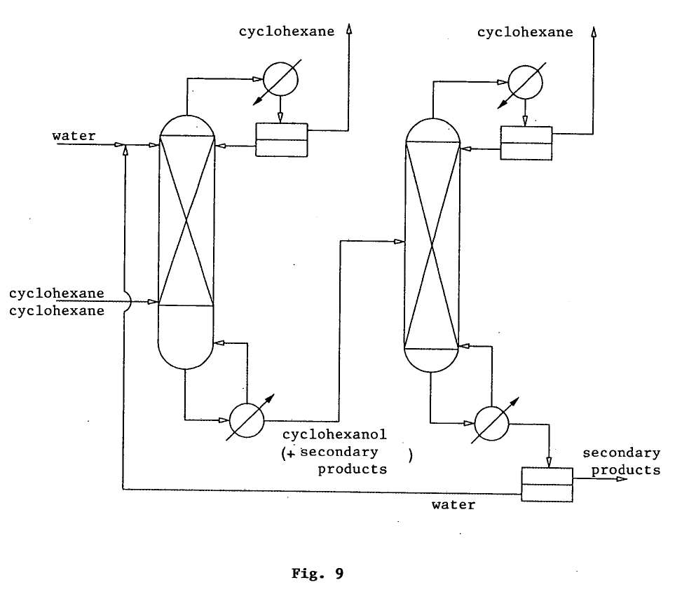

FIG. 9: another variant of the process according to the invention for separation of the mixture cyclohexene/cyclohexane.

In order to implement the process of the invention at least two reactive distillation columns are required which are coupled to each other. The secondary product(s), depending on the mixture of substances being separated and the reaction partners introduced may be removed in or after the first column, the forming column, or in or after the second column from the splitting column.

The removal of the secondary product or products is accomplished by devices which are suitable for discharging the secondary products from the system. For example, a separate nonreactive distillation column or a side outlet or a phase separator (decanter) can be provided.

Depending on the properties of the specific mixture of substances it is more favorable to remove the secondary product in or after the splitting column or to return it together with the reaction partner to the forming column and separate it in or after this column. If several secondary products appear, it can also be advantageous to remove them from the coupled system both in or after the forming column and in or after the splitting column. For example, with a nonreactive reactive [sic] distillation column depending on the boiling order the latter may accumulate as the head or bottom product of said column.

Depending on whether the secondary product is a higher boiling or lower boiling substance, the secondary product is then removed from the head or the bottom of the column in question.

FIG. 1 shows a device with a column system for implementing a preferred variant of the process of the invention. The column system 9 consists of two coupled reactive distillation columns which are composed of the forming column 10 and the splitting column 11. A nonreactive distillation column 12 is interposed between them. Refluxing devices 14 are provided at the head and at the bottom of the individual columns 10, 11 and 12. The process for reactive separation with this column system 9 is as follows:

A mixture of substances, i.e. a mixture of at least two components 1, is introduced into the forming column 10. The mixture is composed of at least one inert component 2 and at least one reactive component 3. At the same time a reaction partner 7 is introduced into the forming column 10 which reacts in the forming column 10 with the reactive component or reactive components 3 of the mixture to form a reaction product or several reaction products 4. The lower-boiling inert components 2 distill off in pure form from the head of the forming column 10. From the bottom of the forming column 10 then a mixture of secondary products and reaction product(s) 6 is passed and transferred to the nonreactive distillation column 12. From the bottom of the nonreactive distillation column 12 the secondary products 5 are removed in pure form. At the same time the reaction product or products 4 pass over from the head of the nonreactive distillation column 12 to the splitting column 11. There the reaction products 4 split into the pure components 3 and into the reaction partner 7. The pure reactive components 3 escape through the head of the splitting column 11, while the reaction partner 7 is removed from the foot of the splitting column 11 in a mixture with the secondary products 5 formed in the splitting column 11. The mixture of reaction partner and secondary products 8 is fed back to the forming column.

The secondary products can also be taken off from the bottom of the forming column 10. This preferred variant is shown in FIG. 4. Here a device with a column system is shown in which a side outlet is provided on the forming column.

The device includes a column system 9 which is composed of the forming column 10 and the splitting column 11. At the bottom of the forming column 10 the secondary products 5 are drained off in pure form. This variant of the process of the invention proceeds as follows:

A mixture of at least two components, at least one inert component 2 and at least one reactive component 3, is introduced into the forming column 10. At the same time a reaction partner 7 is introduced into the forming column 10. The reaction partner 7 forms a reaction product or reaction products 4 with the reactive component 3. The reaction products 4 are removed from the forming column 10 through a vapor side outlet 13. At the same time the secondary products 5 are discharged in pure form from the bottom of the forming column 10.

The reaction products 4 are split in the splitting column 11 back into components 3 and the reaction partner 7. The components 3 leave the head of the splitting column 11 in pure form. The reaction partner 5 at the bottom of the splitting column 11 forms a mixture 8 with the secondary products 5 which have formed in the splitting column 11. This mixture leaves the bottom of the splitting column 11 and is reintroduced into the forming column 10. As in the first variant of the process of the invention in each case reflux devices 14 are provided at the head and the bottom of the two coupled columns 10 and 11.

According to the invention the high boiling secondary products are removed from the cycle in order to avoid accumulation. This can be accomplished either in separate separating devices (e.g., distillation columns) or by vapor or liquid side outlets from the component in question. In this case basically two cases can be distinguished.

a) The secondary products are higher boiling than the reaction products or than the reaction partner. The separation takes place as the bottom product of a separate nonreactive distillation column or as the bottom product of the RDC with side outlet.

b) The secondary products are lower boiling than the reaction product or than the reaction partner. The separation is accomplished as a head product from a separate nonreactive distillation column or as a side outlet of the RDC.

With the process according to the invention basically those components which display a higher reactivity can be separated from all mixtures of substances consisting of close-boiling components. As an example one can mention the separation of at least one reactive component from a mixture of close-boiling hydrocarbons. Reactive components in this case are especially alkenes, preferably tertiary olefins or cycloalkenes.

In the separation of mixtures with alkenes at least one reactive component of this mixture can be etherified, hydrated or esterified.

As an example in the following the esterification of a tert-olefin is presented as follows:

tert-olefin+alcohol⇄alkyl tert-alkyl ether

As tert-olefins, for example, isobutene, isoamylene, isohexene and isoheptene from the corresponding C₄-C₇ mixtures can be mentioned.

As a rule straight-chained or branched, monovalent or polyvalent alcohols are used for the esterification. The alcohol preferably displays one to five carbon atoms. For example here one can mention methanol, ethanol, propanol, isopropanol, n-butanol, sec-butanol.

For the case of the above tert-olefins, for example, the following ethers are formed: methyl tert-butyl ether (MTBE), tert-amyl methyl ether, methyl tert-hexyl ether, methyl tert-heptyl ether, ethyl tert-butyl ether, methyl tert-amyl ether, ethyl tert-hexyl ether, ethyl tert-heptyl ether and the corresponding ethers from formation with propanols and butanols.

The hydration of an olefin can be represented by the example of a tertiary olefin as follows:

tert-olefin+water⇄tert-alcohol

For this case as tert-olefins, for example, isobutene, isoamylene, isohexene and isoheptene from the various C₄-C₇ mixtures can be mentioned. The tert-alcohols in this case correspond to tert-butyl alcohol, tert-amyl alcohol, tert-hexyl alcohol and tert-heptyl alcohol.

It is also possible according to the invention by using the present process to separate one cycloalkene of close-boiling hydrocarbons. This is accomplished, for example, by esterification of a cycloalkene according to the following formula:

cycloalkene+carboxylic acid⇄carboxylic acid ester.

Cyclopentene, cyclohexene or cycloheptene can be cited as examples of suitable cycloalkenes.

A carboxylic acid is used as the esterification agent. The carboxylic acid can be a saturated or unsaturated, branched or unbranched carboxylic acid with two to ten carbon atoms and one or more acid groups. As examples here formic acid, acetic acid, acrylic acid, and methacrylic acid can be cited.

The carboxylic acid esters formed in this case are then, for example, cyclopentyl formate, cyclopentyl acetate, cyclopentyl acrylate, cyclopentyl methacrylate, cyclohexyl formate, cyclohexyl acetate, cyclohexyl acrylate, and cyclohexyl methacrylate and the corresponding esters from formation with the other carboxylic acids.

The reaction conditions depend on the mixture of substances to be separated. The temperatures achieved in reactive distillation depend directly on the pressure established in the column and correspond to the boiling temperatures of the mixtures or pure substances in each case. In the case of olefin separation by esterification, pressures of 0.1-11 bar (corresponding to temperatures of 220° C.) are realized, preferably pressures of 5-8 bar (corresponding to temperatures up to 200° C.). In the case of olefin separation by hydration, pressures of 0.1-6 bar (temperatures up to 160° C.) are used, preferably pressures of 24 bar (temperatures up to 140° C.). The esterification of cycloalkenes takes place at pressures of 0.1-10 bar (corresponding to temperatures of up to 250° C.).

Catalysts can be used to carry out the reactions in order to increase the reaction conversions. As a rule strongly acid substances are used as catalysts.

Both heterogeneous catalysts and homogeneous catalysts come into consideration. Among the heterogeneous catalysts one can name, for instance, sulfonic acid ion exchange resins which are introduced into the columns in packages or in bulk. The homogeneous catalysts include acids such as sulfuric acid. The latter have the advantage that fewer secondary products are formed, although it is more difficult to position the reaction zone.

It is sometimes advisable to use different catalysts in the forming column and in the splitting column. It has been found that distinctly smaller quantities of catalysts must be used in the splitting column than in the forming column in order to prevent the formation of secondary products.

The device to carry out the reactive separation of a liquid mixture of substances according to the invention includes at least two coupled reactive distillation columns 9 which are composed of a forming column 10 and a splitting column 11. The coupled reactive distillation column system 9 also includes at least one device for removing the secondary products.

In a preferred variant the device for removing the secondary products represents a nonreactive distillation column 12. This nonreactive distillation column 12 is positioned between the forming column 10 and the splitting column 11. The reaction product 6 formed in the forming column 10 from the reactive components and the fed-in reaction partner 7 passes into the column 12. At the bottom of the nonreactive distillation column 12 then the secondary products 5 are discharged in pure form.

In another variant of the device according to the invention the device for removing the secondary products represents a vapor side outlet 13. This side outlet 13 is provided in the lower part of the forming column 10. The reaction product is transferred to the splitting column 11 through the vapor side outlet 13.

For the case that, depending on the operating conditions, a phase decomposition into two coexisting liquid phases occur, such as an aqueous and an organic phase, the secondary products can advantageously be discharged through at least one of the phase separators (decanters). In a preferred variant a phase separator is provided at the head of each column. Refer to the previous variants for the process of discharging the secondary products.

Ordinarily refluxing devices or evaporator devices 14 are provided on the columns 10 and 11 as well as on the column 12.

The device according to the invention can be used especially for the production of important base materials for subsequent syntheses. Thus, for example, isobutene is widely used in the plastics industry as a basis for polymers and polymer blends. Also the secondary products obtained in pure form can be further utilized directly. One example is the diisobutene which accumulates during the esterification of isobutene which can be used as a fuel additive (anti-knock agent).

With the processes according to the invention the advantages of the principle of reactive separation and of the reactive distillation column system are advantageously combined with each other. Both the forming and also the splitting column are well known, but in each case only individually without the recycling of the reaction partner. However, until now it was not known that a totally coupled system of reactive distillation columns could be used for the forming and the splitting of the reaction product with recycling of the reaction partner and removal of secondary products. According to the invention the individual reactive distillation columns are directly interconnected. The secondary products according to the invention are removed from the column system in order to avoid their accumulation and to assure a good yield and purity of the components being separated.

The removal of the secondary products can be accomplished by means of other separating columns or through a side outlet or through at least one phase separator. The second or third variants, depending on the material system in question, is frequently an economical solution.

The following examples serve to explain the present invention in more detail.

### EXAMPLES

### Example 1

### Separation of the Material Mixture Isobutene/n-butene

As FIG. 2 shows a mixture of close-boiling substances, isobutene and n-butene, is fed into a system of two coupled reactive distillation columns and one nonreactive distillation column. In the forming column 2 the reactive component isobutene reacts with methanol which is initially charged as the reaction partner, to form the high boiling ether MTBE. In the case of complete conversion of the reactive component isobutene, the head product of the columns consists of pure n-butene. The MTBE is transferred together with the secondary product diisobutene (DIB) to the nonreactive distillation column. There the MTBE/DIB mixture is decomposed into the individual components. DIB is discharged at the bottom of this column in high purity and can be utilized for other process steps. The MTBE is transferred from the head of the nonreactive distillation column to the following splitting column where the ether is again completely split into the original components isobutene and methanol. The lower boiling component isobutene is separated in pure form as the head product while the methanol is returned to the forming column together with the DIB.

The column system is operated at 6 bar, all inflows are supplied as saturated liquids. The MTBE forming column has 30 stages, the condenser at the head representing stage 1 and the evaporator at the bottom stage 30. Stages 2 through 12 are packed with catalysts and form the reactive zone. All inflows into this column are fed to stage 12, therefore at the lower end of the reaction zone. The nonreactive DIB separation column also has 30 stages, the feed is supplied as stage 12. The MTBE splitting column has 50 stages of which stages 2-20 form the reaction zone. The feed is introduced at stage 10,

In the following table the volume flows (in mole/s) of all columns and their molar states (in mol. %) are shown. D in this case always denotes the distillate stream through the head of the column, B the bottom product stream. It can be seen that all products leave the installation with very high purities. 70% of the isobutene used can be obtained in pure form, the remaining 30% is converted into diisobutene. The required heating capacities of the evaporator are also reported.

| | | | | | | | | |
|---|---|---|---|---|---|---|---|---|
| | Quan- | | | | | | | |
| Stream | tity | nB | iB | MeOH | MTBE | DIB | DME | H₂O |

MTBE forminq column (Q = 371 kW)

| | | | | | | | |
|---|---|---|---|---|---|---|---|
| Feed₁ | 3.832 | 70.0 | 30.0 | | | | |
| Feed₂ | 0.014 | | | 100.0 | | | |
| Recy | 1.004 | | | 93.1 | | 6.5 | 0.3 |
| D | 2.693 | 99.6 | 0.2 | | | | 0.2 |
| B | 1.111 | | | | 85.1 | 14.9 | |

DIB separating column (Q = 67.2)

| | | | |
|---|---|---|---|
| Feed | 1.111 | 85.1 | 14.9 |
| D | 0.946 | 99.9 | |
| B | 0.165 | | 100.0 |

DIB splitting column (Q = 439 kW)

| | | | | | | | |
|---|---|---|---|---|---|---|---|
| Feed | 0.946 | | | 99.9 | | | |
| D | 0.819 | 99.0 | 0.2 | 0.4 | | 0.4 | |
| B | 1.004 | | 93.1 | | 6.5 | | 0.3 |

A small proportion of the methanol is reacted in another secondary reaction into dimethyl ether (DME) and water so that a small external methanol feed must be provided.

FIG. 3 with the concentration profiles of the individual components in the three columns (a-c) shows that the inert component n-butene, the reactive component isobutene, and the secondary product DIB are taken off in very high purities at the corresponding locations.

### Example 2

### Separation of the System Isobutene/n-butene

Here a vapor side outlet for a stream of vapor is provided in the MTBE forming column. The design of this column system corresponds essentially to the design with DIB column described in example 1. The only difference in the device consists in the fact that the forming column has 40 stages here while the vapor side outlet is installed at stage 22. The feed of the splitting column consists of saturated vapor.

The following table shows streams and their compositions. Again the products are obtained in high to very high purities. 82% of the isobutene consumed can be obtained in pure form. The remaining 18% are reacted into diisobutene.

| | | | | | | | | |
|---|---|---|---|---|---|---|---|---|
| | Quan- | | | | | | | |
| Stream | tity | nB | iB | MeOH | MTBE | DIB | DME | H₂O |

MTBE formin column (Q = 414 kW)

| | | | | | | | |
|---|---|---|---|---|---|---|---|
| Feed₁ | 3.832 | 70.0 | 30.0 | | | | |
| Feed₂ | 0.014 | | | 100.0 | | | |
| Recy | 1.168 | | | 92.9 | | 6.7 | 0.3 |
| D | 2.689 | 99.7 | 0.1 | | | | 0.2 |
| Vside | 1.101 | | | | 99.7 | 0.2 | |
| B | 0.101 | | | | 0.1 | 99.9 | |

DIB splitting column (Q = 492 kW)

| | | | | | | | |
|---|---|---|---|---|---|---|---|
| Feed | 1.101 | | | 99.7 | 0.2 | | |
| D | 0.950 | 99.0 | 0.2 | 0.4 | | 0.4 | |
| B | 1.168 | | 92.9 | | 6.7 | | 0.3 |

As FIG. 5 shows through this vapor side outlet pure MTBE is drawn off and fed to the MTBE splitting column. The diisobutene (DIB) is taken off in pure form as a liquid at the bottom of the forming column.

FIG. 5 shows the concentration profiles in the two columns for the components involved. One column fewer is used than in the variant in example 1.

### Example 3

### Separation of the System Isobutene/n-butene

In contrast to example 2, a phase separator is used to remove the secondary product diisobutene. A corresponding separation schematic is shown in FIG. 7.

The TBA forming columns is operated at a pressure of 10 bar. External feeds are supplied as saturated liquids. The column consists of 30 stages, the evaporator in the bottom representing stage 30. The top part of the column up to and including stage 14 is filled with catalyst and forms the reactive zone. Pure water is supplied to stage 2, the butene mixture to stage 14. The vapor mixture taken off at the head of the column (stage 1) is partially condensed, the more highly volatile n-butene being obtained in pure form as a vapor. The remaining components are totally condensed and separated in a phase separator (decanter) into an organic and an aqueous phase. The aqueous phase is returned to the column, while the organic phase is taken off as a secondary product stream.

The TBA splitting column is operated at a pressure of 3 bar. This column also consists of 30 stages. The bottom product stream from the forming column is supplied as a feed to stage 14. Stages 3 through 27 of the column are designed as reactive. As in the case of the forming column the vapor stream partially condenses at the head so that isobutene is taken off in ultrapure form as vapor and the remaining components are in turn split up into two phases. In contrast to the forming column, here also the organic phase is almost completely returned to the column. The concentration profiles of the two reactive columns are shown in FIG. 8.

In the following table the quantity streams (in mole/h) of all columns and their molar compositions (in mol. %) are shown. Nb in this case denotes the vaporous butene product streams, Norg the streams of the organic phase carried off from the decanter and B the bottom product stream. It can be seen that all products leave the installation in high to very high purities. About half of the isobutene used can be obtained in pure form. The remainder is predominantly reacted into diisobutene. The required heating capacities of the evaporators are also stated.

| | | | | | | |
|---|---|---|---|---|---|---|
| Stream | Quantity | nB | iB | H₂O | TBA | DIB |

TBA forming column (Q = 86.3 kW)

| | | | | | | |
|---|---|---|---|---|---|---|
| Feed | 4.1387 | 50.0 | | | | |
| Feed₂ | 0.0257 | | | 100.0 | | |
| Nb | 2.0708 | 99.8 | 0.2 | | | |
| Norg | 0.5430 | | | 3.8 | 0.4 | 95.8 |
| B | 1.3161 | | | 25.4 | 71.3 | 3.3 |

TBA splitting column (Q = 478.0 kW)

| | | | | | |
|---|---|---|---|---|---|
| Feed | 1.3161 | | 25.4 | 71.3 | 3.3 |
| Nb | 0.9307 | 100.0 | | 99.7 | 0.2 |
| Norg | 0.0421 | | 1.4 | 3.9 | 94.7 |
| B | 1.2703 | | 100.0 | | 6.7 |

### Example 4

### Separation of the System Cyclohexene/cyclohexane

The separation is performed according to the schematic:

cyclohexane+water⇄cyclohexanol (intermediate product) cyclohexane+cyclohexanol⇄cyclohexane+cyclohexanone (secondary product 1)

2 cyclohexanol⇄dicyclohexyl ether+water (secondary product 2)

cyclohexane inert (to reaction with water)

Depending on the catalyst used operating pressures between 1 and 10 bar are envisaged. As FIG. 9 reveals the separation of cyclohexene and cyclohexane takes place in two coupled reactive distillation columns. The secondary products cyclohexanone and dicyclohexyl ether are removed in the decanter in the reflux stream. The upper part of the cyclohexanol forming columns is provided with catalysts and forms the reaction zone. The bottom part is designed to be nonreactive and serves to separate the intermediate product cyclohexanol. The mixture to be separated is fed in below the reaction zone, the reaction partner water above it. The vapor stream at the head of the column is totally condensed, as a result of which an aqueous and an organic phase are formed in the phase separator (decanter). The organic phase consists of the highly pure product cyclohexane and is separated. The aqueous phase is returned to the column.

The intermediate product cyclohexanol and any secondary products which have formed are fed to the splitting column which is designed to be fully reactive. At the head of this column one obtains a stream of vapor which condenses completely as in the case of the forming column and is separated into two liquid phases. As the organic phase the product cyclohexane is taken off in high purity. The aqueous phase is returned to the column. The bottom stream from the splitting column is also fed to a decanter in order to remove the secondary products formed in the organic phase. The aqueous phase is returned to the forming column.

1. Process for separating at least one reactive component from a liquid mixture of substances in a system of at least two coupled reactive distillation columns with a forming column and a splitting column in which at least one secondary product is removed from the system.

2. Process as in claim 1, characterized by the fact that the secondary product is removed in or after the forming column.

3. Process as in claim 1, characterized by the fact that the secondary product is removed in or after the splitting column.

4. Process as in one of claims 1 to 3, characterized by the fact that a separate nonreactive distillation column or a side outlet are provided for removal of the secondary product.

5. Process as in claim 4, characterized by the fact that the secondary product is removed at the head or at the bottom of the nonreactive distillation column.

6. Process as in at least one of claims 1 to 5, characterized by the fact that the secondary product is formed in the splitting column.

7. Process as in claim 6, characterized by the fact that the secondary product is returned to the forming column together with the reaction partner.

8. Process as in claims 6 and 7, characterized by the fact that the secondary product is taken off from the bottom of the forming column.

9. Process as in claims 6 and 7, characterized by the fact that the secondary product is transferred with the reaction product to a nonreactive distillation column.

10. Process as in claim 9, characterized by the fact that the secondary product is taken off from the bottom of the nonreactive distillation columns.

11. Process as in at least one of claims 1 to 10, characterized by the fact that at least one reactive olefin is removed from a close-boiling mixture of substances.

12. Process as in claim 11, characterized by the fact that the reactive olefin is etherified, hydrated or esterified.

13. Process as in claim 11 or 12, characterized by the fact that etherification is performed with a straight-chained or branched, monovalent or polyvalent alcohol.

14. Process as in claim 13, characterized by the fact that the alcohol displays one to five carbon atoms.

15. Process as in at least one of claims 11 to 14, characterized by the fact that a mixture of isobutene/n-butene is separated with methanol as etherification agent.

16. Process as in at least one of claims 1 to 10, characterized by the fact that at least one reactive cycloalkene is separated from a close-boiling mixture of substances.

17. Process as in claim 16, characterized by the fact that a reactive cycloalkene is esterified.

18. Process as in claim 16 or 17, characterized by the fact that a carboxylic acid is used as the esterification agent.

19. Process as in claim 18, characterized by the fact that the carboxylic acid is a saturated or unsaturated, branched or unbranched carboxylic acid with two to ten carbon atoms.

20. Process as in at least one of claims 1 to 19, characterized by the fact that the separation of the reactive components takes place in the presence of a catalyst.

21. Process as in claim 20, characterized by the fact that a strongly acid substance is used as the catalyst.

22. Device for separation of at least one reactive component from a liquid mixture of substances according to at least one of claims 1 to 21 with the features:
at least two coupled reactive distillation columns (9) which are composed of a forming column (10) and a splitting column (11), and
at least one device for removing the secondary product or secondary products.

23. Device as in claim 22, characterized by the fact that the device for removing the secondary products represents a nonreactive distillation column (12).

24. Device as in claim 23, characterized by the fact that the device for removing the secondary products represents a side outlet (13) or a phase separator.

25. Device as in at least one of claims 22 to 24, characterized by the fact that reflux devices or evaporator devices (14) are provided on the columns (10) and (11) as well as on the column (12).

26. Application of a device according to at least one of claims 12 to 25 in the field of fuel production and in the plastics industry.
